(19) United States
(12) Patent Application Publication
(10) Pub. No.: US 2009/0151550 A1
(43) Pub. Date: Jun. 18, 2009

(54) Concepts for Weldable Ballistic Products for Use in Weld Field Repair and Fabrication of Ballistic Resistant Structures

(76) Inventor: Israel Stol, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/335,254

(22) Filed: Dec. 15, 2008

Related U.S. Application Data
(60) Provisional application No. 61/007,740, filed on Dec. 14, 2007.

(51) Int. Cl. F41H 5/04; B23K 20/08

(52) U.S. Cl. 89/36.02; 228/107

(57) ABSTRACT

A joinable, ballistic resistant product and methods of manufacturing same are disclosed, comprising at least one ballistic resistant layer; and at least one joinable layer bonded to the at least one ballistic resistant layer; wherein the at least one ballistic resistant layer is composed of a material that sufficiently resists ballistic threats at a lower areal density than comparable materials joinable to a damaged entity; and wherein the at least one joinable layer is composed of a material that is capable of sufficient joinder to the damaged entity.

### CROSS-REFERENCE TO RELATED APPLICATIONS

This application claims the benefit of and priority to U.S. Provisional Application Ser. No. 61/007,740, filed on Dec. 14, 2007, the entirety of this application hereby incorporated by reference.

### BACKGROUND OF THE INVENTION

The invention relates to a product consisting of a ballistic resistant material bonded to a joinable material, as well as methods for manufacturing same and for use of same in repair of entities damaged by ballistic, explosive, and/or manufacturing (e.g. welding) events or otherwise in need of ballistic hardening. The present invention relates generally to the field of ballistic product manufacture and welding, wherein the disclosed joinable and ballistic resistant products (“products”) are constructed of a material which has superior ballistic resistance. In addition, a portion of the ballistic products are constructed of material that can readily be joined (i.e. via welding) around and about damaged portions of a vehicle, building or other ballistically hardened structure.

### BRIEF SUMMARY OF THE INVENTION

In one embodiment, a joinable, ballistic resistant product is disclosed, comprising: at least one ballistic resistant layer; and at least one joinable layer bonded to the at least one ballistic resistant layer; wherein the at least one ballistic resistant layer is composed of a material that sufficiently resists ballistic threats at a lower areal density than comparable materials joinable to a damaged entity; and wherein the at least one joinable layer is composed of a material that is capable of sufficient joinder to the damaged entity.

In one embodiment, the at least one ballistic layer and the at least one joinable layer are bonded through an explosion bonding process.

In one embodiment, the at least one ballistic layer and the at least one joinable layer are bonded through a hot rolling process.

In one embodiment, the ballistic resistant layer is a material selected from the group consisting of Aluminum Association 5083 alloy, Aluminum Association 6013 alloy, Aluminum Association 6061 alloy, Aluminum Association 2xxx alloy, Aluminum Association 5456 alloy, and high hard steel.

In one embodiment, the joinable layer is a material selected from the group consisting of Aluminum Association 5083 alloy, and Aluminum Association 6061 alloy.

In one embodiment, the thickness of the ballistic resistant product is no more than 1.5 in.

In one embodiment, the thickness of the ballistic resistant layer is no more than 1.0 in.

In one embodiment, the thickness of the joinable layer is no more than 0.5 in.

In one embodiment, the areal density of the ballistic resistant product is no more than 24 psf.

In one embodiment, the areal density of the ballistic resistant product is no more than 20 psf.

In one embodiment, the ballistic resistant product is more bendable than comparable materials that resist ballistic threats.

In one embodiment, the maximum radius to thickness ration of the ballistic resistant product is 2.5 for a ballistic resistant product of 0.125″ thickness.

In one embodiment, the maximum radius to thickness ration of the ballistic resistant product is 4 for a ballistic resistant product of 0.5″ thickness.

In one embodiment, the ballistic resistant product is more bendable than comparable materials that resist ballistic threats.

In one embodiment, the maximum radius to thickness ration of the ballistic resistant product is 2.5 for a ballistic resistant product of 0.125″ thickness.

In one embodiment, the maximum radius to thickness ration of the ballistic resistant product is 4 for a ballistic resistant product of 0.5″ thickness.

In one embodiment, a method for manufacturing an ballistic resistant product is disclosed, comprising the steps of bonding at least one ballistic resistant layer and at least one joinable layer to form a ballistic resistant product.

In one embodiment, the method further comprises joining a joinable portion of an ballistic resistant product to a damaged entity; and sealing the ballistic resistant product to the damaged entity.

In one embodiment, a method for manufacturing an ballistic resistant product is disclosed, comprising the steps of excavating the damaged entity so as to facilitate placement of an ballistic resistant product; joining a placed ballistic resistant product to the damaged entity excavation via a ballistic resistant product joinable layer; and sealing the placed ballistic resistant product to the damaged entity excavation.

In another embodiment, the sealing step is not needed so as to maintain corrosion resistance of the ballistic resistant layer.

For the purposes of describing and claiming the present invention, the following terms are defined:

“Aluminum Association Series Alloy” means the 4-digit wrought aluminum alloy identification system maintained by the Aluminum Association. The first digit (Xxxx) indicates the principal alloying element, which has been added to the aluminum alloy and is often used to describe the aluminum alloy series, i.e., 1xxx series, 2xxx series, 3xxx series, up to 8xxx series (see Table 1).

TABLE 1

| Alloy Series | Principal Alloying Element |
|---|---|
| 1xxx | 99.000% Minimum Aluminum |
| 2xxx | Copper |
| 3xxx | Manganese |
| 4xxx | Silicon |
| 5xxx | Magnesium |
| 6xxx | Magnesium and Silicon |
| 7xxx | Zinc |
| 8xxx | Other Elements |

The second single digit (xXxx), if different from 0, indicates a modification of the specific alloy, and the third and fourth digits (xxXX) are arbitrary numbers given to identify a specific alloy in the series. Example: In alloy 5183, the number 5 indicates that it is of the magnesium alloy or 5xxx series, the 1 indicates that it is the 1^{st} modification to the original alloy 5083. The 83 is an arbitrary number identifying the specific base alloy.

“Adhesive Bonding” means the use of adhesive to join two parts together. In one embodiment, such adhesive may be any type of epoxy-based adhesive or any other adhesive capable of creating sufficient joinder relative to aluminum-aluminum, aluminum-steel, and/or aluminum-titanium bonding.

“Areal Density” means the volumetric density of a material multiplied by one square foot of area multiplied by the thickness of the material needed to stop a given ballistic threat, typically assessed as pounds per square foot. For example, for a typical threat level, relative areal density required of a given material to resist ballistic penetration may be as follows:

| Steel | Aluminum | Titanium |
|---|---|---|
| Rolled: 24.0 | 5083 H131: 25.9 | 18.0 |
| High Hard: 20.4 | 7039: 21.3 | |

“Ballistic Hardening” means designing and/or modifying an entity so as to increase that entity's ballistic resistance.

“Ballistic Resistance” means the ability of ballistic resistant material to withstand a ballistic threat, assessed as a function of both the areal density of a material and the nature of a given ballistic threat.

“Ballistic Threat” means any ballistic projectile traveling at a defined velocity, wherein the nature and velocity of the projectile create a potential for damage upon projectile impact.

“Ballistic Resistant” means: a material exhibiting at least one of the following properties in the context of a blast event or ballistic threat: (1) deformation resistance; (2) penetration resistance; and or (3) spall resistance.

“Bendability” means capable of being bent, without fracture, and may be measured, among other means, by reference to ASTM Standard No. E-290 (2004). One measure of bendability may be expressed as the ratio of radius to plate thickness. In one embodiment, R/T minimum values for bendability over a 90 degree angle without fracture may be as follows:

| Material | Thickness | R/T Value |
|---|---|---|
| High Hard Steel | ½″ | 6 |
| High Hard Steel | ⅛″ | 4 |
| Aluminum 5083 | ½″ | 3.75 |
| Aluminum 5083 | ⅛″ | 2.5 |

“Corrosion Resistance” means capable of resisting any of a variety of corrosive processes, including but not limited to oxidative corrosion; galvanic corrosion; accelerated pitting; and/or intergranular corrosion.

“Damaged Entity” means any material in need of ballistic resistance reinforcement and/or hardening.

“Deformation Resistance” means: resistance to a change in shape due to an applied force. This can be a result of tensile (pulling) forces, compressive (pushing) forces, shear, bending, and/or torsion (twisting). Deformation is often described in terms of strain.

“Density” means: mass per unit volume.

“Explosion Bonding” means joining two different parts together by using the explosion bonding process. The explosion bonding process is based on affecting a metallurgical bond between different parts. In one embodiment, the explosion bonding is carried out by the following steps: 1) Placing the parts next to each other in an overlapping fashion with a constant predetermined gap between them and placement of a layer of explosive powder (e.g. dynamite) over one of the parts. 2) Detonating the explosive powder at one or more points, in the pattern and sequence most appropriate for the application, thus accelerating the part closest (or bearing) to the explosive layer towards the “stationary” part(s) placed away from the explosive powder, across the gap between them. Upon impact of the accelerated part against the “stationary” (i.e. the one placed away from the explosive powder) part, a fast moving shock wave is initiated at the interface between the parts, which in turn causes the interface between the parts to rapidly propagate away from the original impact point, while at the same time ejecting a jet of molten and solid materials in front of the propagating interface. This jet, which is comprised of materials lifted and blown off the mating surfaces of the parts being welded, acts to scavenge and remove the surface oxides and contaminants (e.g. oxides, dirt, etc.) from the mating surfaces of the parts. The explosion bonding between the parts is achieved by the combination of high temperature and pressure at the moving interface, which in combination with the removal of surface oxides and contaminants leads to the coalescence and metallurgical bonding of the parts.

“Excavating” or “Machining” means to make hollow by removing the inner part; make a hole or cavity in; form into a hollow, as by digging.

““GMA” or “GMAW” Welding”” means gas metal arc welding.

“High Hard Steels” means steels with high hardness and strength, which contain significant amounts (e.g. 0.4%) of carbon, and at times other elements, which, when given an appropriate heat treatment, impart to these steels their required properties (e.g. ballistic resistance) in service. High Hard Steels typically attain their required strength and ballistic resistance by quenching and transformation into martensite, which is subsequently heat treated into tougher phases (e.g. bainite).

“Hot Rolling” is the process of rolling a heated and thus softened part, and then passing it through sets of rollers under pressure, which make it thinner. When more than two parts are heated, softened and passed together through rollers under pressure, they can be forced to be metallurgically joined (welded) together.

“Joinable” means capable of being securely fastened, for example by welding, bonding, adhesion, and/or swaging; or via a given process, for example, welding or adhesive or explosive bonding.

“Joinable Portion” means: a portion of a material exhibiting joinable characteristics.

“Penetration Resistance” means that a material is not ruptured or penetrated as the result of a ballistic or concussive force applied thereto.

“Sealing” means rendering a material impervious to corrosion inducing elements and processes, for example, water infiltration; galvanic corrosion; oxidative corrosion; accelerated pitting; and/or intergranular corrosion.

“Spall Resistance” means that a material is able to resist the incidence and/or severity of “spall” (defined as both the surface failure process by which delamination, fragmentation or breakoff of a material (e.g., ballistic resistant plate) occurs opposite the point of impact of a ballistic projectile or other applied shock on that material, and the fragmented or broken-off material resulting from such a process.

“Sufficient Joinder” means sufficient joint strength and durability for the required application; for example, to maintain the position of the joinable, ballistic resistant product once joined to a damaged entity. In one embodiment, sufficient joinder may be measured with reference to tensile yield strength (TYS). In one embodiment, TYS of 20 ksi is required to sufficiently join 5083 H131 to itself.

“Swaging” means a method of joining two parts via use of localized mechanical deformation so as to mechanically interlock the two parts.

### BRIEF DESCRIPTION OF THE SEVERAL VIEWS OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is a depiction of a damaged entity 1. As indicated, the impact and interaction of the ballistic threat with the damaged entity results in a bullet (or ballistic projectile) hole. The impact of the ballistic threat with the damaged entity results in the hole, and the displacement of ballistic resistant plate material by the impact of the ballistic threat may result in the formation of impact/penetration induced ridges and bulges 2 comprised essentially of this displaced material.

FIG. 2 is a depiction of one embodiment of a first step in field repair of a damaged entity. As indicated, the impact/penetration induced ridges and bulges are ground off of 3 the damaged entity. This creates a substantially flat surface on the damaged entity, onto which a repair material can more easily be attached.

FIG. 3 is a depiction of another embodiment of a second step in field repair of a damaged entity; that is, the placement and fastening of a product in accordance with the present invention over a damaged surface of a damaged entity. As depicted, the product may optionally be comprised of several layers, optionally including a layer of “joinable” material 4 proximate the attachment point of the ballistic resistant product to the damaged entity, a layer of ballistic resistant material 5 (in one embodiment, titanium or ballistic-resistant steel) bonded to the “joinable” layer; and an optional clad layer 6 bonded to the ballistic resistant material layer.

FIG. 4 is a depiction of another embodiment of a third step in field repair of a damaged entity damaged by a ballistic threat; that is, the process of attaching the “joinable” aluminum layer of the product to the surface of the damaged entity (in one embodiment, via the use of GMA Fillet arc welding 7), and of optionally utilizing a sealant 8 (which may, in several nonexclusive embodiments, be comprised of sealant, paint, adhesive material, or some combination thereof) placed over the product or edges of the product where the damaged entity material boundary is located proximate to the joinable layer—ballistic resistant layer attachment point so as, for example, to minimize the rapidity and effect of corrosion on the damaged entity, ballistic resistant layer and/or joinable layer.

FIG. 5 is an additional embodiment of the invention, e.g. a depiction of the concept for augmenting the ballistic resistance of welds made between parts that comprise the damaged entity; that is, the process of creating a cavity 9 in the damaged entity so as to inlay at least a portion of the ballistic resistant product 10 within the underlying damaged entity so that at least a portion of the ballistic-resistant layer 5 of the ballistic resistant product 10 is physically positioned over the portion of the damaged entity that contains a welded joint with corresponding metallurgically, and hence ballistically, weakened Heat Affected Zones (HAZ's) adjoining welds 11, and thus further minimize corrosion and augment ballistic resistance of the HAZ's. In FIG. 5, the ballistic resistant product of the claimed invention is inlaid to the existing damaged entity, and is isolated from corrosion-inducing forces external to the damaged entity by means of sealing/filling and/or optional covers or clad layers (such as aluminum adhesive tape or paint) 12 attached to the exterior surface of the ballistic resistant layer and covering at least a portion of the ballistic resistant layer/damaged entity junction.

FIG. 6 is a depiction of an alternative embodiment of use of the ballistic resistant product of the claimed invention; that is, the process of creating a cavity 9 in the damaged entity so as to inlay at least a portion of the ballistic resistant product 10 within the existing damaged entity so that at least the ballistic resistant layer 5 of the ballistic resistant product 10 is physically positioned within the damaged entity and is, at the conclusion of the process, fully encapsulated within the existing damaged entity. This full encapsulation isolates the ballistic resistant layer of the ballistic resistant product from corrosion-inducing elements present in the air or otherwise on the exterior of the damaged entity, and is thus capable of resisting corrosion-inducing forces external to the damaged entity.

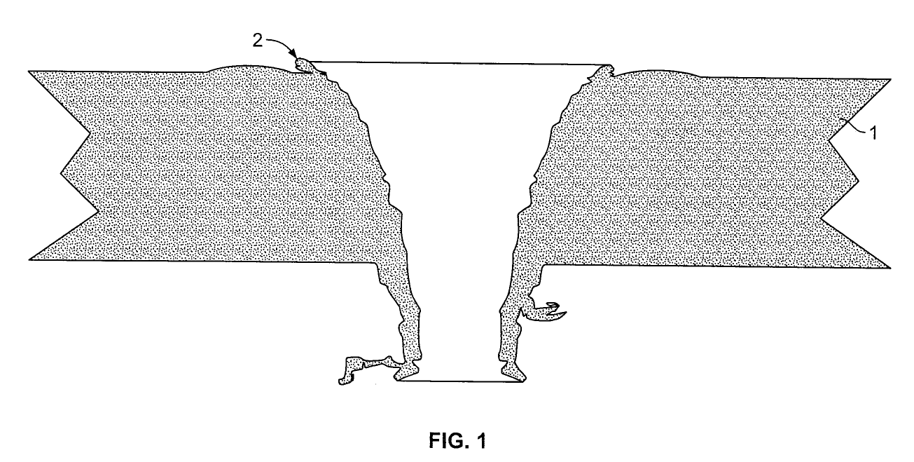

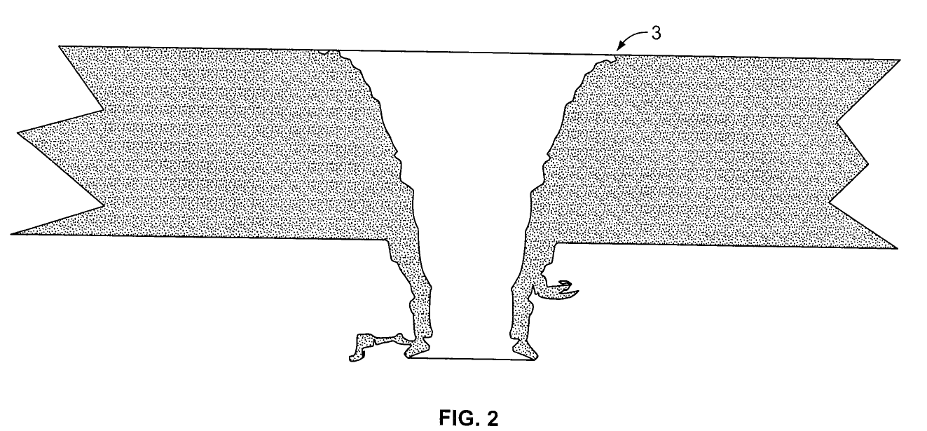

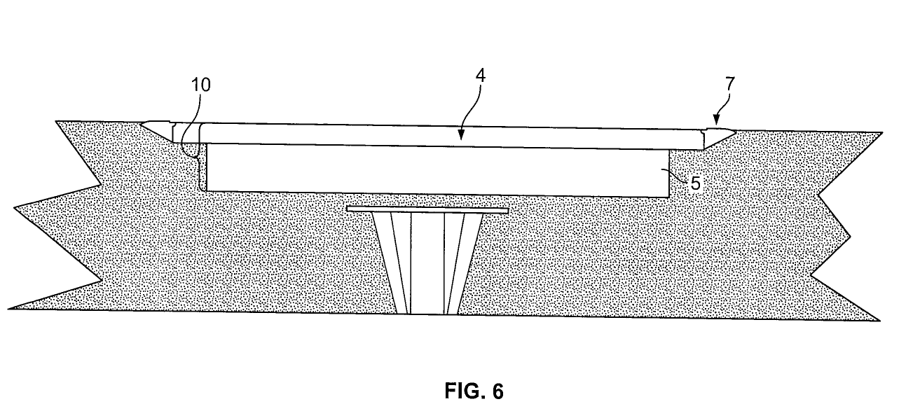

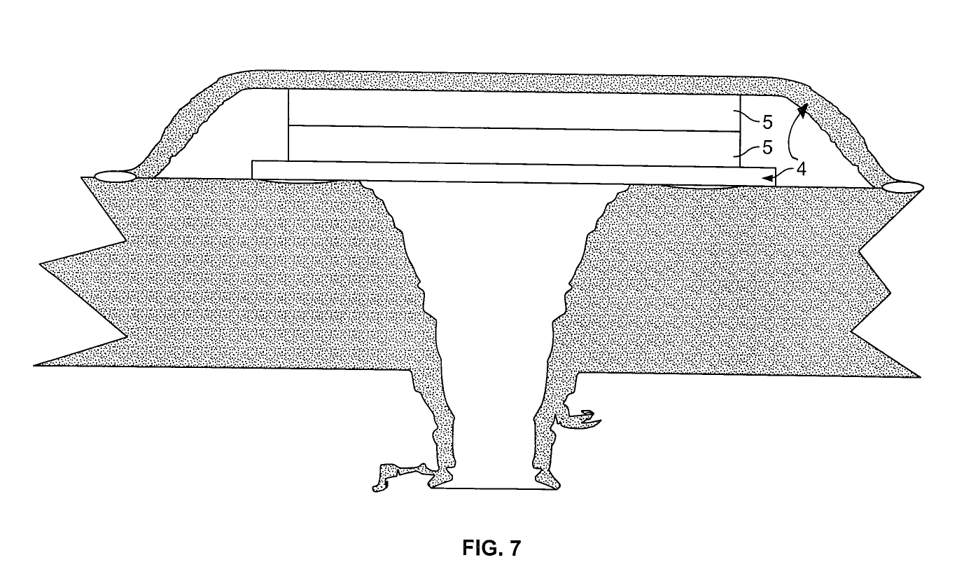

More specifically, FIG. 6 demonstrates one embodiment of how the use of Gas Metal Arc (GMA) or Friction Stir (FSW) or other welds between the joinable portion of the ballistic-resistant product 4 and the damaged entity can serve to completely encapsulate the ballistic resistant material portion of the ballistic product. FIG. 6 discloses both a cavity whose broader portion is closer to the exterior surface of the damaged entity, and a ballistic threat resistant material wherein the joinable aluminum layer 4 bonded to ballistic resistant layer 5 of the ballistic resistant product overhangs the ballistic resistant layer 5 of the ballistic resistant product at one or more edges. This overhang meshes with the broadened portion of the cavity 9 towards the exterior of the damaged entity, and thus provides a joinable layer proximate to a damaged entity surface. The resultant joints encapsulate the ballistic resistant layer 5 of the ballistic resistant product between the joinable aluminum layer and the damaged entity itself, thus sealing and isolating the ballistic resistant layer 5 from corrosion-inducing forces external to the damaged entity. The design of FIG. 6 also allows for elimination of a three layer structure by eliminating the need for a third, interior joinable layer bonded to the opposite side of the ballistic-resistant layer, thus enabling the use of a bi-layer joinable layer/ballistic resistant material ballistic resistant product having at least one edge where the joinable layer overhangs the ballistic resistant layer.

FIG. 7 is a depiction of an alternate embodiment of the use of the product 10 of the present invention in field repair of damaged entities. As shown in FIG. 7, the ballistic resistant layer 5 of FIG. 7 may be “doubled” for additional protection of larger portions of a damaged entity and/or for additional reinforcement of ballistic resistant layer so as to withstand higher ballistic threat levels. In an alternative embodiment, as shown in FIG. 7, the “joinable portion” 4 of the present invention may be situated as an external, overlay layer that is external to the single or multiple ballistic threat resistant layers and is joinable directly to the exterior of the ballistic resistant layer and damaged entity by any number of appropriate joining techniques. Thus, a second, joinable layer between the damaged entity and ballistic-resistant layer may also be utilized.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed invention.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

In one embodiment, the instant invention encompasses the construction, installation, and attachment of ballistic resistant, composite products.

In one embodiment, products are utilized in field repair of damaged entity structures (e.g., vehicles, ship halls, etc.) that have been damaged by ballistic threats during combat.

In another embodiment, products are utilized in augmentation of ballistic resistance of ballistic resistant plate joints, regardless of whether those ballistic resistant plate joints have been previously damaged. Such joints may be found in all manner of ballistic resistant structures (e.g., vehicles, ship halls, etc.).

In another embodiment, the products of the instant invention may be applied to all manner of ballistically hardened structures, which may be made out of all manner of different materials (e.g. 5083, 6013-Aluminum, Steel, Titanium, etc.). tempered, worked, and/or aged in any of a variety of manners. Ballistic resistant aluminum alloys include 5083- H131, 6013-T6, 6061-T6, and 5456-H131. High Hard (HH) steel ballistic resistant plates include the steels under Mil Specification MIL-A-46100 and Rolled Homogeneous Armor steel plates (RHA) under Mil Specification MIL-A-12560.

In another embodiment, ballistic resistant products are utilized as a method of augmenting the ballistic resistance of joints between sections of ballistic resistant plate, whether the ballistic resistant plate is itself damaged or undamaged. In one embodiment, these joints are comprised of welds. In further embodiments, these joints may be arc, friction-stir, gas metal arc welds (GMAW), shielded metal arc weld (SMAW) or other weld types as applied to welding products of the instant invention to ballistic resistant plating, or welding adjacent sections of ballistic resistant plating together. In another embodiment, placement of the ballistic resistant layer of the products of the instant invention over the junction point of adjacent ballistic resistant plates augments the ballistic resistance of these joints and the ballistic resistance of the weakened heat affected zones (HAZ's) of the joints.

In another embodiment, the ballistic resistant products are composed of materials which incorporate superior ballistic resistance to areas (i.e. holes, cracks, tears, and/or joints) of the damaged entities/structures in need of ballistic hardening. In other embodiments, these materials having superior ballistic resistance, include materials selected from the group comprising, but not limited to, high hard steels, titanium, and aluminum alloys of Aluminum Association designations 5000 and 7000 (e.g. 5083, 6013-Aluminum, Steel, Titanium, etc.). Ballistic resistant aluminum alloys include 5083- H131, 6013-T13, 6061-T6, and 5456-H131. High Hard (HH) steel ballistic plates include the steels under Mil Specification MIL-A-46100 and Rolled Homogeneous Armor steel plates (RHA) under Mil Specification Mil-A-12560.

In another embodiment, the ballistic resistant product may exhibit comparable ballistic resistance to known materials, wherein the ballistic resistant product of the instant invention exhibits a lower areal density required to stop a given ballistic threat relative to a known joinable ballistic resistant material. In one embodiment, the ballistic resistant product of the instant invention exhibits increased joinability relative to a known ballistic resistant material having lower areal density than the ballistic resistant product of the instant invention. In one embodiment, the ballistic-resistant product may have a higher Areal Density than aluminum, but lower than that of steel. In another embodiment, the ballistic resistant product may have a higher Areal Density than aluminum, but lower than that of titanium. In one embodiment, the areal density of a ballistic resistant product may be between 15-30 psf. In one embodiment, the areal density of a ballistic resistant product may be between 18-25 psf. In one embodiment, the areal density of a ballistic resistant product may be between 19-21 psf. In one embodiment, the areal density of a ballistic resistant product may be approximately 20 psf. In one embodiment, the areal density of a ballistic resistant product may be between 20-25 psf. In one embodiment, the areal density of a ballistic resistant product may be between 21-25 psf.

In another embodiment, the ballistic resistant product may exhibit comparable ballistic resistance to known materials, wherein the ballistic resistant product of the instant invention exhibits greater bendability than known materials. In one embodiment, the ballistic resistant product may be less bendable than aluminum and more bendable than steel. In another embodiment, the ballistic resistant product may be less bendable than aluminum and more bendable than titanium. In one embodiment, the bendability of the ballistic resistant product as assessed relative to a radius/thickness ration is 1-6. In one embodiment, the bendability of the ballistic resistant product as assessed relative to a radius/thickness ration is 2-5. In one embodiment, the bendability of the ballistic resistant product as assessed relative to a radius/thickness ration is 2-4. In one embodiment, the bendability of the ballistic resistant product as assessed relative to a radius/thickness ration is 3-4.

In another embodiment, the ballistic resistant product may exhibit comparable bendability to known materials, wherein the ballistic resistant product of the instant invention exhibits a lower areal density required to stop a given ballistic threat relative to a known bendable ballistic resistant material. In one embodiment, the ballistic resistant product of the instant invention exhibits increased joinability relative to a known bendable ballistic resistant material having lower areal density than the ballistic resistant product of the instant invention.

In another embodiment, the ballistic resistant product may exhibit comparable ballistic resistance to known materials, wherein the ballistic resistant material of the instant invention is thinner (either the ballistic resistant portion, the joinable portion, or the overall material) than known materials. In another embodiment, the ballistic resistant product may exhibit comparable ballistic resistance to known materials, wherein the ballistic resistant product of the instant invention exhibits a lower areal density required to stop a given ballistic threat relative to a known joinable ballistic resistant material. In one embodiment, the ballistic resistant product of the instant invention exhibits increased joinability relative to a known ballistic resistant material being thinner than the ballistic resistant product of the instant invention.

In another embodiment, the ballistic resistant material may exhibit comparable corrosion resistance to known materials, wherein the ballistic resistant material of the instant invention exhibits greater bendability than known materials.

In another embodiment, the ballistic resistant material may exhibit comparable corrosion resistance to known materials, wherein the ballistic resistant material of the instant invention exhibits lower areal density against a given ballistic threat.

In another embodiment, the ballistic resistant material may exhibit comparable corrosion resistance to known materials, wherein the ballistic resistant material of the instant invention is thinner (either the ballistic resistant portion, the joinable portion, or the overall material) than known materials.

In another embodiment, the materials used in the instant invention represent an advancement over conventional monolayer ballistic resistant repair materials. In one embodiment, the instant invention bi-layer material exhibits a decreased areal density; increased bendability; decreased spalling potential; increased joinability; decreased or similar corrosion resistance, and at least equivalent anti-ballistic performance as compared to known anti-ballistic monolayer materials. In another embodiment, increased portability of repair materials as compared to known ballistic resistant repair materials is observed, attributable to at least one of the above-recited characteristics.

In another embodiment, the ballistic resistant material and joinable material of the bi-layer ballistic resistant material of the instant invention may be bonded. In one embodiment, such bonding is accomplished by explosion bonding, hot rolling, adhesive bonding, and/or bolt bonding. In one embodiment, such bonding is a welding. In one embodiment, such welding is facilitated by any technique or combination of techniques known in the art, including stick welding, friction stir welding, SMAW, and/or GMAW.

In another embodiment, the bi-layer ballistic resistant material of the instant invention and the damaged entity may be joined. In one embodiment, such joining is accomplished by welding. In one embodiment, such welding is facilitated by any technique or combination of techniques known in the art, including stick welding, friction stir welding, SMAW, and/or GMAW.

In another embodiment, the instant invention products are further composed of materials that can be readily fusion weldable (i.e. “Joinable”) to these damaged structures. “Fusion weldable” materials include, but are not limited to, Aluminum Association 5000, 6000, and 7000 series alloys, e.g. 5083, 7003, and 6061.

In another embodiment, the instant invention products may be attached to damaged entities by methods other than welding. These methods of attaching materials (including disparate layers of the products of the instant invention as well as attachment of the products themselves to all manner of ballistic resistant plate) include, but are not limited to, Explosion-Bonding, Hot-Rolling, Adhesive-Bonding, Mechanical fasteners, Swaging, and combinations thereof.

In another embodiment, by employing ballistic resistant products comprised of a “Ballistic” portion and a “Joinable” portion, it is possible to transport such products in the field (by “Logistical” trucks) and use smaller, thinner and hence more compact and “pliable” (i.e., more compliant and flexible over non-flat areas) repair products then bulkier ballistic resistant materials utilized in the construction and/or ballistic hardening of the damaged entity. This smaller, thinner, more compact and more pliable product material makes the logistical challenge of transporting and installing plate in the field easier. The proposed products are expected to be 1.5 to 3 times lighter than the bulkier monolithic aluminum plates. In one embodiment, the ballistic resistant layer of the instant invention is between 0.25 and 0.57 inches thick. In one embodiment, the ballistic resistant layer of the instant invention is between 0.30 and 0.70 inches thick. In one embodiment, the ballistic resistant layer of the instant invention is between 0.40 and 0.60 inches thick. In one embodiment, the joinablelayer of the instant invention is between 0.125 and 0.5 inches thick. In one embodiment, the joinable layer of the instant invention is between 0.25 and 0.4 inches thick.

In another embodiment, the instant invention is fully compatible with present repair practices of the US Army in the field, which consist of employment of “logistical trucks” whose crews carry out the repairs in the field, before the damaged vehicles are sent back to army depots for more permanent repair and refurbishment. These “logistical trucks” are equipped with tools (e.g. grinders, vises, hammers, pneumatic wrenches, etc.) and portable GMA welding equipment with which they carry out the repairs. At the present time, the Gas Metal Arc Welding (GMAW) and/or Shielded Metal Arc Welding (SMAW) or Stick-Electrode welding are among the preferred joining processes for use in field repair of ballistically hardened structures.

In another embodiment, holes due to ballistic damage in a damaged entity may be relatively large, and the ballistic resistance of these damaged areas can be restored in the field, either by stacking two of the new products on top of each other (FIG. 7), or by use of a ballistic product with a thicker ballistic resistant portion. It is anticipated that in the field, the “logistical trucks” will be provided with products of different size, thickness and shape (e.g. flat and bent for repair of corners).

In another embodiment, use of a thinner and more bendable material may enable use of such products on highly curved (or discontinuous) portions of ballistic resistant plate, ballistic resistant plate joints, and ballistically hardened structures. For example, use of a thinner and more bendable material may enable use of the product of the instant invention on curved sections of damaged entities and/or ballistically hardened structures.

In another embodiment, in order to prevent corrosion between dissimilar materials (for example, the “Ballistic Resistant Portion”, the “Joinable Portion”, and the ballistically hardened structure) from corrosion-inducing forces external to the damaged entity, a sealant is introduced.

In one embodiment, use of different sealants is contemplated, including elastomeric silicone, polysulfide and acrylic based sealants in paste or ‘paintable” forms.

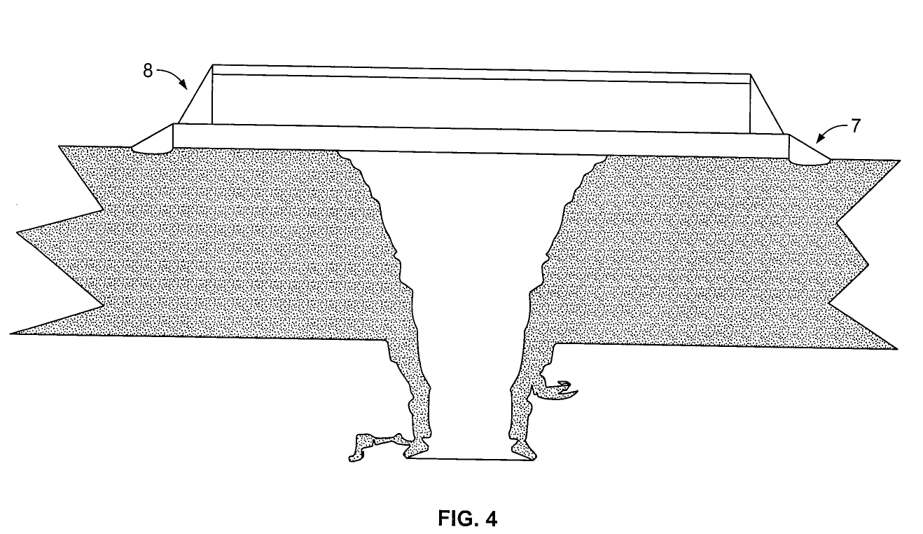

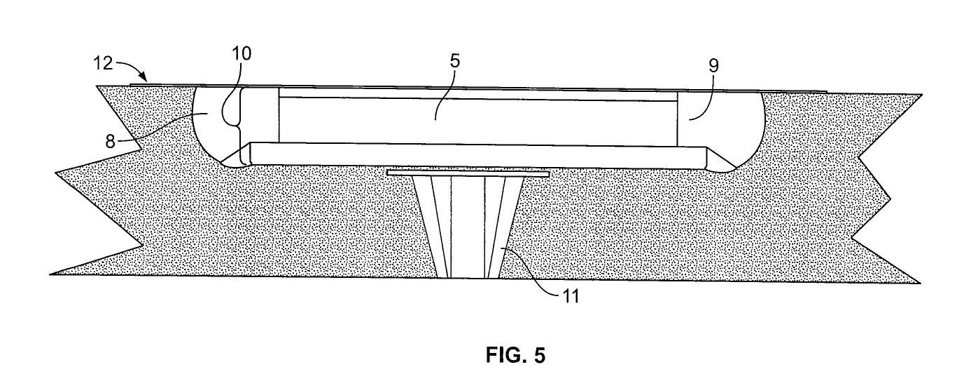

In one embodiment, such sealants can be used to isolate the joints (for example, GMA welds) from the elements (FIGS. 4 and 5). In another embodiment, the new products are used to augment the ballistic resistance of joints (e.g. GMA or Friction Stir welds) (FIGS. 5 and 6). In another embodiment, the instant invention also allows the use of paint or adhesive tape in conjunction with the sealant (FIG. 5).

In another embodiment, the sealant material may be used to seal any physical gaps between the layers of the bilayer ballistic resistant material; between the ballistic resistant material and the damaged entity; and/or in excavated regions of the damaged entity.

In another embodiment, the sealant material may be any material known to impart at least one of the following characteristics: increased wear resistance, increased corrosion resistance, and/or increased joinability. In another embodiment, the sealant material may perform a volume filling function.

In another embodiment, the geometry of the cavity within the ballistic resistant allows inlay of a specifically shaped ballistic product where at least one surface of the aluminum exterior portion of the ballistic product overhangs the ballistic resistant material layer of the ballistic product. (FIG. 6).

In another embodiment, the geometry of the cavity within the underlying ballistic resistant and/or the spatial relationship of the exterior joinable and interior ballistic resistant material layers of the ballistic product facilitates a joinable layer/damaged entity weld that results in full encapsulation of the ballistic resistant material layer of the ballistic product within the underlying damaged entity, thus sealing and isolating the ballistic resistant material layer of the ballistic resistant product from corrosion-inducing forces external to the damaged entity and producing a seal capable of reducing the effects of corrosion-inducing forces external to the damaged entity (eg, with regard to any damaged entity/joinable layer/ballistic resistant material layer contact points).

In another embodiment, the design of FIG. 6 also allows for elimination of the interior joinable layer of aluminum bonded to the ballistic resistant layer of the ballistic resistant product, thus enabling use of a bi-layer aluminum/ballistic resistant material product having at least one edge where the aluminum overhangs the ballistic resistant material.

In one embodiment, the joinable layer that can be used for the purpose of the instant invention are any aluminum or aluminum alloy layers have joinability characteristics.

In another embodiment, the role of the third, optional aluminum layer (or clad layer) is to provide a protective layer or coating, which upon application of the sealant or paint to the edges of the ballistic resistant portions of the products, prevents the accelerated corrosion of the ballistic resistant portions of the products, upon exposure to corrosion-inducing forces external to the damaged entity.

In another embodiment, GMA and FSW welding processes are suitable for this application. The machining of the pocket into the ballistic resistant plate does weaken this area. However, the superior ballistic properties of the ballistic resistant portion of these products more than make up for this weakening.

In another embodiment, optional clad material is used as an exterior surface for the instant ballistic-resistant products. In another embodiment, such clad material may impart one or more of the following characteristics: increased wear resistance; increased corrosion resistance, increased joinability.

In another embodiment, a method for repairing a damaged entity is disclosed. In another embodiment, excess material resulting from a ballistic impact/penetration is removed from the damaged entity. Following removal, the bi-layer material of the instant invention (with the joinable layer in direct contact with the damaged entity and the ballistic resistant material layer physically separated from the damaged entity by the bonded joinable layer) is subsequently joined to the damaged entity. In another embodiment, the outside surface of the ballistic resistant layer is clad with a distinct material; in one embodiment, series 1100 aluminum.

In another embodiment, a method for repairing a damaged entity is disclosed. In another embodiment, excess material resulting from a ballistic impact/penetration is removed from the damaged entity. Following removal, the bi-layer material of the instant invention (with the joinable layer in direct contact with the damaged entity, and the ballistic resistant layer physically separated from the damaged entity by the bonded joinable material) is subsequently joined to the damaged entity. In another embodiment, the outside surface of the ballistic resistant layer is clad with a distinct material; in one embodiment, series 1100 aluminum. In another embodiment, sealant (prior or subsequent to joining) is applied to all exposed ballistic resistant/joinable material junctions and/or all exposed ballistic resistant layers.

In another embodiment, a method for repairing a damaged entity is disclosed. In another embodiment, excess impact/penetration resultant material is removed from the place of damage of the damaged entity. Following removal, a cavity may be excavated within the damaged entity wherein the ballistic resistant product is at least partially inlaid to the excavated damaged entity, with joinable layer in direct contact with the damaged entity material and ballistic resistant material layer physically separated from the damaged entity by the bonded joinable material and/or by sealant and/or open space. A clad or cover layer (which may be, for instance, paint, adhesive tape, or a physical barrier such as series 1100 aluminum) is subsequently joined to the damaged entity and to a second joinable layer joined to the opposite side of the ballistic resistant layer as the first joinable layer. In one embodiment, the clad or cover layer is then flush with the outer surface of the damaged entity.

In another embodiment, a method for repairing a damaged entity is disclosed. In another embodiment, excess impact/penetration resultant material is removed from the place of damage of the damaged entity. Following removal, a cavity may be excavated within the damaged entity wherein the ballistic product is at least partially inlaid, with ballistic resistant material in direct contact with the damaged entity material and held in place by an outer layer of joinable material joined to the damaged entity. In one embodiment, the joinable material may overhang the ballistic resistant material, thereby providing a section of joinable material which may fit into a excavated section of the damaged entity (in one embodiment, where the section of joinable material is in direct contact with the damaged entity excavation). In one embodiment, a clad or cover layer (which may be, for instance, paint, adhesive tape, or a physical barrier such as series 1100 aluminum) is subsequently joined to the damaged entity and to a joinable layer that is itself already joined to the ballistic resistant layer. In one embodiment, the cladding or cover layer is then flush with the outer surface of the damaged entity.

In another embodiment, the geometry of the cavity within the damaged entity allows inlay of a specifically shaped ballistic resistant product where at least one surface of the joinable layer of the ballistic resistant product overhangs the ballistic resistant material layer of the ballistic product. (FIG. 6).

In another embodiment, the geometry of the cavity within the ballistic resistant and/or the spatial relationship of the exterior joinable and interior ballistic resistant material layers of the ballistic resistant product facilitates a damaged entity/joinable layer weld that results in full encapsulation of the ballistic resistant material layer of the ballistic resistant product within the underlying damaged entity, thus sealing and isolating the ballistic resistant material layer of the ballistic resistant product from corrosion-inducing forces external to the damaged entity,

In another embodiment, the design of FIG. 6 also allows for elimination of the interior joinable layer of aluminum bonded to the ballistic resistant material, thus enabling use of a bi-layer joinable layer/ballistic resistant layer ballistic resistant product having at least one surface where the joinable layer overhangs the ballistic resistant material.

In another embodiment, multilayer structures may be utilized comprising at least one joinable layer and at least one ballistic-resistant layer, optionally utilizing multiple layers of each. In one embodiment, such products may be manufactured and/or used either by stacking two ballistic-resistant layers on top of each other (FIG. 7) or by use of a ballistic-resistant product with a thicker “Ballistic Resistant Portion”. In one embodiment, these multiple ballistic-resistant layers may be themselves bonded, forming a multilayer (e.g. trilayer) structure with the at least one bonded joinable layer. It is anticipated that in the field, the “logistical trucks” will be provided with products of different size, thickness and shape (e.g. flat and bent for repair of comers).

### EXAMPLE 1

### Bonding Ballistic Resistant Portion to Joinable Portion

In one example, explosion welding (EXW), a solid state process is used to join the ballistic resistant layer to the joinable layer. Welding is accomplished by accelerating one of the components at extremely high velocity through the use of chemical explosives. Explosion welding can produce a bond between two metals that cannot necessarily be welded by conventional means. The process does not melt either metal, rather, it plasticizes the surfaces of both metals, causing them to come into intimate contact sufficient to create a weld. This is a principle similar to other non-fusion welding techniques, a group that includes friction welding and inertial welding. Large areas can be bonded extremely quickly, and the weld itself is very clean, because the surface material of both metals is violently expelled during the reaction.

### EXAMPLE 2

### Bonding Ballistic Resistant Portion to Joinable Portion

In another example, hot rolling is utilized to bond the at least one joinable layer and at least one ballistic resistant layer. A slab or billet is passed or deformed between a set of work rolls and the temperature of the metal is generally above its recrystallization temperature, as opposed to cold rolling, which takes place below this temperature. Hot rolling permits large deformations of the metal to be achieved with a low number of rolling cycles. As the rolling process breaks up the grains, they recrystallize maintaining an equiaxed structure and preventing the metal from hardening. Hot rolled material typically does not require annealing and the high temperature will prevent residual stress from accumulating in the material resulting better dimensional stability than cold worked materials.

### EXAMPLE 3

### Bonding Bi-layer Ballistic Resistant Material to Damaged Entity

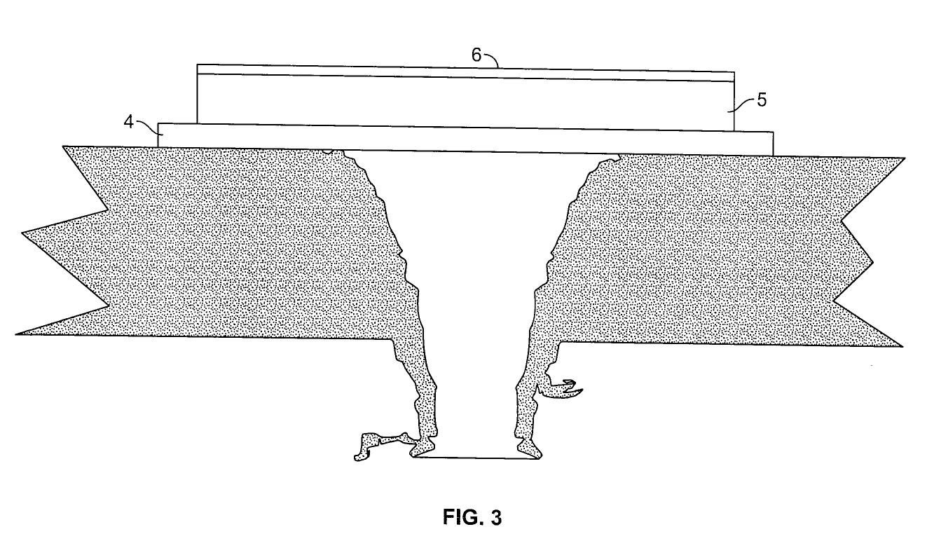

In one example, FIG. 3 is a depiction of a second step in the field repair of an entity damaged by a ballistic threat; that is, the placement and fastening of a product in accordance with the present invention over a damaged surface of a damaged entity. As depicted, the product may optionally be comprised of several layers, optionally including a joinable layer 4 proximate a ballistic resistant layer 5 (in one embodiment, titanium or ballistic steel); and an optional clad layer 6 bonded to the ballistic resistant material layer. Materials may be welded using any technique known in the art, including those described here.

### EXAMPLE 4

### Bonding Encapsulated Bi-layer Ballistic Resistant Material to Excavated Damaged Entity

FIG. 5 is an additional example and embodiment of the invention, e.g. a depiction of the concept for augmenting the ballistic resistance of welds made between parts that comprise the damaged entity; that is, the process of creating a cavity in the damaged entity 9 so as to inlay at least a portion of the ballistic resistant product 10 within the existing damaged entity so that at least a portion of the ballistic-resistant layer 5 of the ballistic resistant product 10 is physically positioned over the portion of the damaged entity that contains welded joints with corresponding metallurgically, and hence ballistically weakened Heat Affected Zones (HAZ's) adjoining welds 11, and thus further minimize corrosion, and augment the ballistic resistance of the HAZ's. In FIG. 5, the ballistic resistant product of the claimed invention is inlaid to the existing damaged entity, and is isolated by use of a sealing/filling means and/or optional covers (such as aluminum, adhesive tape, or paint) 12 attached to the exterior surface of the damaged entity and covering at least a portion of the ballistic resistant product/damaged entity junction. Materials may be welded using any technique known in the art, including those described here.

### EXAMPLE 5

### Comparable Study of Known Material to New Bi-layer Material When Both are Bonded to Damaged Entity

In one embodiment, a comparable study will be carried out to determine the relative ballistic resistance (as a function of ballistic resistant material areal density) of known ballistic damage repair materials, as compared to the bi-layer and bi-layer plus sealant materials of the instant invention. It is expected that the material of the instant invention will demonstrate an improved (lower) areal density, with at least comparable or improved corrosion resistance and/or joinability, as compared to known materials, when comparably tested in a repair process similar to that depicted in FIG. 3.

### EXAMPLE 6

### Comparable Study of Known Material to New Bi-layer Material When Both are Encapsulated Within Excavated Damaged Entity

In one embodiment, a comparable study will be carried out in order to determine the relative ballistic resistance (as a function of ballistic resistant material density and thickness) of known ballistic resistant materials as compared to the bilayer and bilayer-plus sealant materials of the instant invention. It is expected that the material of the instant invention will demonstrate an improved (e.g., lower) areal density with at least comparable corrosion resistance and/or joinability as compared to known materials, when comparably tested in a repair process similar to that depicted in FIG. 4.

### EXAMPLE 7

### Comparable Study of Known Materials and New Bilayer Materials as a Function of Thickness and Total Thickness Plotted Against Ballistic Performance

In one embodiment, a comparable study will be carried out in order to determine the relative ballistic resistance (as a function of ballistic resistant material areal density) of known ballistic damage repair materials as compared to the bi-layer and bi-layer plus sealant materials of the instant invention. It is expected that the material of the instant invention will demonstrate an improved (lower) areal density, with at least comparable corrosion resistance and/or joinability as compared to known materials, when comparably tested in a repair process similar to that depicted in FIG. 5.

### EXAMPLE 8

### Comparable Study of Known Materials and New Bi-layer Materials as a Function of Thickness and Total Thickness Plotted Against Corrosion Resistance

In one embodiment, a comparable study will be carried out in order to determine the relative corrosion resistance (as a function of ballistic resistant material utilized and installation/sealing of such material in a damaged entity) of known ballistic damage resistant materials as compared to the bi-layer and bi-layer plus sealant bi-layer ballistic resistant products and/or installed bi-layer and bi-layer plus sealant bi-layer ballistic resistant products of the instant invention. It is expected that the material of the instant invention will demonstrate at least comparable corrosion resistance with at least comparable ballistic resistance as compared to known materials, when comparably tested in a repair process similar to that depicted in any of the embodiments described herein. In addition, it is expected that the material of the instant invention will show progressively better corrosion resistance as the ballistic resistant layer is better encapsulated.

### EXAMPLE 9

### Comparable Study of Known Material to New Bi-layer Material When Both are Bonded to Damaged Entity

In one embodiment, a comparable study will be carried out to determine the relative ballistic resistance (as a function of ballistic resistant material areal density) of known ballistic damage repair materials, as compared to the bi-layer and bi-layer plus sealant materials of the instant invention. It is expected that the material of the instant invention will demonstrate an improved bendability, with at least comparable or improved corrosion resistance and/or joinability, as compared to known materials, when comparably tested in a repair process similar to that depicted in FIG. 3.

### EXAMPLE 10

### Comparable Study of Known Material to New Bi-layer Material When Both are Encapsulated Within Excavated Damaged Entity

In one embodiment, a comparable study will be carried out in order to determine the relative ballistic resistance (as a function of ballistic resistant material density and thickness) of known ballistic resistant materials as compared to the bilayer and bilayer-plus sealant materials of the instant invention. It is expected that the material of the instant invention will demonstrate an improved bendability with at least comparable corrosion resistance and/or joinability as compared to known materials, when comparably tested in a repair process similar to that depicted in FIG. 4.

### EXAMPLE 11

### Comparable Study of Known Materials and New Bilayer Materials as a Function of Thickness and Total Thickness Plotted Against Ballistic Performance

In one embodiment, a comparable study will be carried out in order to determine the relative ballistic resistance (as a function of ballistic resistant material areal density) of known ballistic damage repair materials as compared to the bi-layer and bi-layer plus sealant materials of the instant invention. It is expected that the material of the instant invention will demonstrate an improved bendability, with at least comparable corrosion resistance and/or joinability as compared to known materials, when comparably tested in a repair process similar to that depicted in FIG. 5.

While a number of embodiments of the present invention have been described, it is understood that these embodiments are illustrative only, and not restrictive, and that many modifications and/or alternative embodiments may become apparent to those of ordinary skill in the art. For example, any steps may be performed in any desired order (and any desired steps may be added and/or any desired steps may be deleted). Therefore, it will be understood that the appended claims are intended to cover all such modifications and embodiments that come within the spirit and scope of the present invention.

What is claimed is:

1. A joinable, ballistic resistant product, comprising:
at least one ballistic resistant layer; and
at least one joinable layer bonded to the at least one ballistic resistant layer;
wherein the at least one ballistic resistant layer is composed of a material that sufficiently resists ballistic threats at a lower areal density than comparable materials joinable to a damaged entity; and
wherein the at least one joinable layer is composed of a material that is capable of sufficient joinder to the damaged entity.

2. The product of claim 1, wherein the at least one ballistic layer and the at least one joinable layer are bonded through an explosion bonding process.

3. The product of claim 1, wherein the at least one ballistic layer and the at least one joinable layer are bonded through a hot rolling process.

4. The ballistic resistant product of claim 1, wherein the ballistic resistant layer is a material selected from the group consisting of Aluminum Association 5083 alloy, Aluminum Association 6013 alloy, Aluminum Association 6061 alloy, Aluminum Association 2xxx alloy, Aluminum Association 5456 alloy, and high hard steel.

5. The ballistic resistant product of claim 1, wherein the joinable layer is a material selected from the group consisting of Aluminum Association 5083 alloy, and Aluminum Association 6061 alloy.

6. The ballistic resistant product of claim 1, wherein the thickness of the ballistic resistant product is no more than 1.5 in.

7. The ballistic resistant product of claim 6, wherein the thickness of the ballistic resistant layer is no more than 1.0 in.

8. The ballistic resistant product of claim 6, wherein the thickness of the joinable layer is no more than 0.5 in.

9. The ballistic resistant product of claim 1, wherein the areal density of the ballistic resistant product is no more than 24 psf.

10. The ballistic resistant product of claim 6, wherein the areal density of the ballistic resistant product is no more than 24 psf.

11. The ballistic resistant product of claim 1, wherein the ballistic resistant product is more bendable than comparable materials that resist ballistic threats.

12. The ballistic resistant product of claim 11, wherein the maximum radius to thickness ration of the ballistic resistant product is 2.5 for a ballistic resistant product of 0.125″ thickness.

13. The ballistic resistant product of claim 11, wherein the maximum radius to thickness ration of the ballistic resistant product is 4 for a ballistic resistant product of 0.5″ thickness.

14. The ballistic resistant product of claim 6, wherein the ballistic resistant product is more bendable than comparable materials that resist ballistic threats.

15. The ballistic resistant product of claim 14, wherein the maximum radius to thickness ration of the ballistic resistant product is 2.5 for a ballistic resistant product of 0.125″ thickness.

16. The ballistic resistant product of claim 14 wherein the maximum radius to thickness ration of the ballistic resistant product is 4 for a ballistic resistant product of 0.5″ thickness.

17. A method for manufacturing an ballistic resistant product, comprising the steps of:
a. Bonding at least one ballistic resistant layer and at least one joinable layer to form a ballistic resistant product

18. The method of claim 17, further comprising the steps of:
b. Joining a joinable portion of an ballistic resistant product to a damaged entity; and
c. Sealing the ballistic resistant product to the damaged entity.

19. A method for repairing a damaged entity, comprising the steps of:
a. Excavating the damaged entity so as to facilitate placement of an ballistic resistant product;
b. Joining a placed ballistic resistant product to the damaged entity excavation via a ballistic resistant product joinable layer; and
c. Sealing the placed ballistic resistant product to the damaged entity excavation.

20. The method of claim 19, wherein the sealing step is not needed so as to maintain corrosion resistance of the ballistic resistant layer.
